(19) United States
(12) Patent Application Publication
(10) Pub. No.: US 2011/0225329 A1
(43) Pub. Date: Sep. 15, 2011

(54) Method for simultaneously switching energy-saving modes of plural computer devices via KVM switc

(75) Inventors: Sharon Lin Charna, Irvine, CA (US); Jim Gau, Irvine, CA (US)

(73) Assignee: At Box Technology Inc., Irvine, CA (US)

(21) Appl. No.: 12/805,357

(22) Filed: Jul. 27, 2010

Related U.S. Application Data
(60) Provisional application No. 61/340,018, filed on Mar. 12, 2010.

(51) Int. Cl. G06F 13/12

(52) U.S. Cl. 710/62

(57) ABSTRACT

The present invention is to provide a method for simultaneously switching energy-saving modes of plural computer devices via a KVM switch including a CPU, a plurality of connection ports, a real-time clock (RTC) and a memory unit, wherein the memory unit stores a timetable containing at least one scheduled time and at least one corresponding energy-saving procedure each including a control instruction. The CPU reads the current time of the RTC and, after determining that the timetable contains a scheduled time corresponding to a current time, reads the control instruction in the energy-saving procedure corresponding to the scheduled time. Then, the CPU sends an energy-saving instruction to the computer device connected to each of the connection ports that are specified in the control instruction, thereby switching the energy-saving modes (e.g., a hibernation mode, sleep mode, OFF mode or ON mode) of the specified computer devices simultaneously.

### FIELD OF THE INVENTION

The present invention relates to a keyboard-video-mouse (KVM) switch, more particularly to a method for simultaneously switching energy-saving modes of a plurality of computer devices (e.g., servers, hosts, etc.) via the KVM switch, so as to enable a user to use the KVM switch for conveniently sending an energy-saving instruction to each of the computer devices and thereby simultaneously switching the computer devices to the desired energy-saving modes.

### BACKGROUND OF THE INVENTION

Recently, with the rapid development of information technology, computer devices (e.g., servers, hosts, etc.) have been extensively used, had ever wider applications, and become indispensable tools for many people in their daily lives as well as at work. In addition, for server managers or those who are enthusiastic in using computer devices, it is not uncommon for a single user to manage or own a plurality of computer devices. Conventionally, a computer device must be connected to a monitor and at least one input device (e.g., a keyboard, mouse, etc.) so as for the user to view the operating information of the computer device through the monitor and to operate the computer device via the at least one input device; therefore, it is impossible to operate a plurality of computer devices respectively without a corresponding number of monitors and input devices. However, the monitors and input devices required not only cost a lot, but also take up considerable space, thus causing trouble and inconvenience to the user.

As a solution to the aforesaid problem, the keyboard-video-mouse (KVM) switch has been developed, whose hardware structure and operation are described as follows. A KVM switch is provided with a central processing unit (CPU), a plurality of connection ports, a display port, and at least one input device port, wherein the CPU is respectively and electrically connected to the connection ports, the display port, and the at least one input device port; each connection port is connected to a computer device; the display port is connected to a monitor; and each input device port is connected to an input device. For instance, the KVM switch described above is connected to computer devices A and B via two connection ports, respectively. When it is desired to operate computer device A, the KVM switch, under the direction of the user, instructs the monitor to display the operating information of computer device A and enables operation of computer device A via the at least one input device. When it is desired to operate computer device B, the KVM switch, under the direction of the user, instructs the monitor to display the operating information of computer device B and enables operation of computer device B via the at least one input device. Thus, a user can switch between and operate a plurality of computer devices by only one set of monitor and input device and be spared the trouble and inconvenience of having to equip each computer device with an individual set of monitor and input device.

Nevertheless, market surveys have shown that commercially available KVM switches still leave much room for improvement. As stated above, to operate different computer devices requires switching back and forth between the computer devices. In other words, it is impossible to operate plural computer devices simultaneously with a KVM switch. For instance, if a user wants to control the energy-saving modes of a plurality of computer devices (e.g., a hibernation mode, a sleep mode, an OFF mode, and an ON mode, the hibernation mode being a mode in which a computer device stores currently processed data into a hard drive and is subsequently turned off to stop receiving power and thereby save energy; the sleep mode being a mode in which a computer device stores currently processed data into a volatile memory, and afterward, only the motherboard and the volatile memory of the computer device continue receiving power to retain the data and thereby reduce power consumption), the user must use the KVM switch to switch the computer devices in turn and control the energy-saving modes of the computer devices sequentially. Assuming the user needs to control the energy-saving modes of 20 computer devices, the KVM switch must be switched for as many times as the number of the computer devices to control the energy-saving modes of all the computer devices. That is to say, the KVM switch does not allow convenient and simultaneous operation of a plurality of computer devices, which not only causes trouble to the user but also significantly lowers the efficiency of the user's operation of the computer devices.

Hence, it is a pressing issue for the related industry to solve the aforesaid problems of the KVM switch, in particular its incapability to control plural computer devices at the same time.

### BRIEF SUMMARY OF THE INVENTION

In view of the foregoing drawbacks of the prior art, the inventor of the present invention put years of practical experience into research and experiment and finally succeeded in developing a method for simultaneously switching the energy-saving modes of plural computer devices via a KVM switch. It is hoped that, with the present invention, a user can use a KVM switch to send an energy-saving instruction to each of a plurality of computer devices conveniently and thereby switch the computer devices to the desired energy-saving modes simultaneously, and in consequence the conventional KVM switch's incapability to control a plurality of computer devices at the same time is effectively overcome.

It is an object of the present invention to provide a method for simultaneously switching energy-saving modes of plural computer devices via a KVM switch, wherein the method is applied to a KVM switch including a CPU, a plurality of connection ports, a real-time clock (RTC), and a memory unit. The memory unit stores a timetable that contains at least one scheduled time and at least one corresponding energy-saving procedure, wherein each energy-saving procedure includes a control instruction. According to the method, the CPU reads the current time of the RTC and, after determining that the timetable contains a scheduled time corresponding to the current time, reads the control instruction in the energy-saving procedure corresponding to the scheduled time. Then, the CPU sends an energy-saving instruction to the computer device connected to each of the plural connection ports that are specified in the control instruction, thereby switching the energy-saving modes (e.g., a hibernation mode, a sleep mode, an OFF mode, and an ON mode) of the specified computer devices simultaneously. With this method, a manager can use the KVM switch to switch a plurality of computer device to the desired energy-saving or working modes at the same time in an efficient and convenient way, instead of having to switch and control the computer devices sequentially, as is conventionally required.

It is another object of the present invention to provide the foregoing method, wherein the KVM switch further includes a display port and an on-screen display (OSD) module. The display port is connected to a monitor. The OSD module is configured for generating a menu which at least includes a time option, a function option, and a connection port option. According to the method, the CPU, when receiving a menu activation instruction, instructs the OSD module to display the menu on the monitor. When subsequently receiving a selection instruction, the CPU matches the selection instruction against the menu. If it is determined that the selection instruction represents a setting instruction, the CPU identifies information corresponding to the time option, the function option, and the connection port option that are selected by the selection instruction and adds to the timetable the specified time indicated by the information of the selected time option and the corresponding specified procedure indicated by the information of the selected function option and the selected connection port option, such that the specified time and the corresponding specified procedure serve as a scheduled time and the corresponding energy-saving procedure, respectively. Thus, a user can set the timetable as needed and thereby instructs the KVM switch to automatically switch a plurality of computer devices to the desired energy-saving modes at a preset time.

### BRIEF DESCRIPTION OF THE SEVERAL VIEWS OF THE DRAWINGS

The invention as well as a preferred mode of use, further objects, and advantages thereof will be best understood by referring to the following detailed description of the preferred embodiments in conjunction with the accompanying drawings, in which:

FIG. 1 is a block diagram of a KVM switch according to the present invention;

FIG. 2 is a flowchart of a first preferred embodiment of the present invention;

FIG. 3 shows a menu generated by an OSD module according to the present invention;

FIGS. 4A and 4B are a flowchart of a second preferred embodiment of the present invention;

FIG. 5 is a block diagram of another KVM switch according to the present invention; and

FIG. 6 is a flowchart of a third preferred embodiment of the present invention.

### DETAILED DESCRIPTION OF THE INVENTION

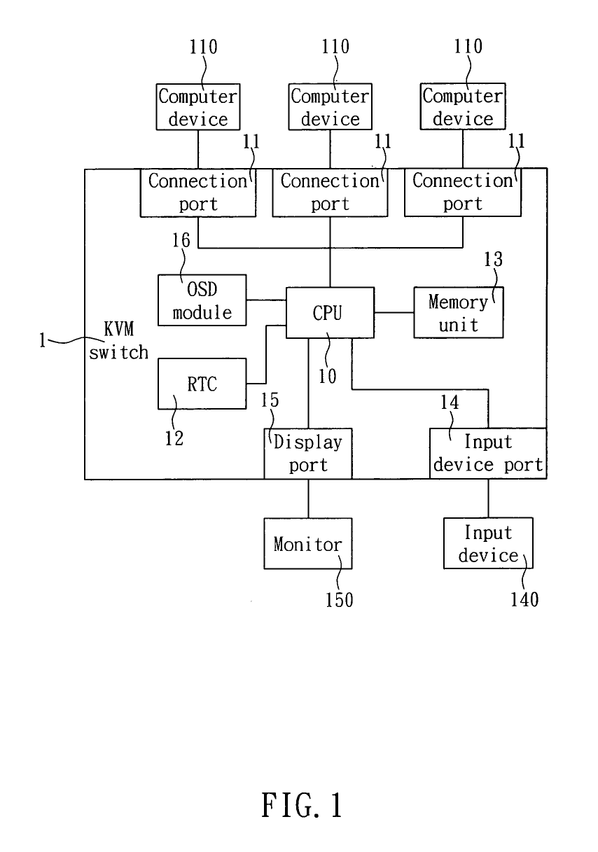

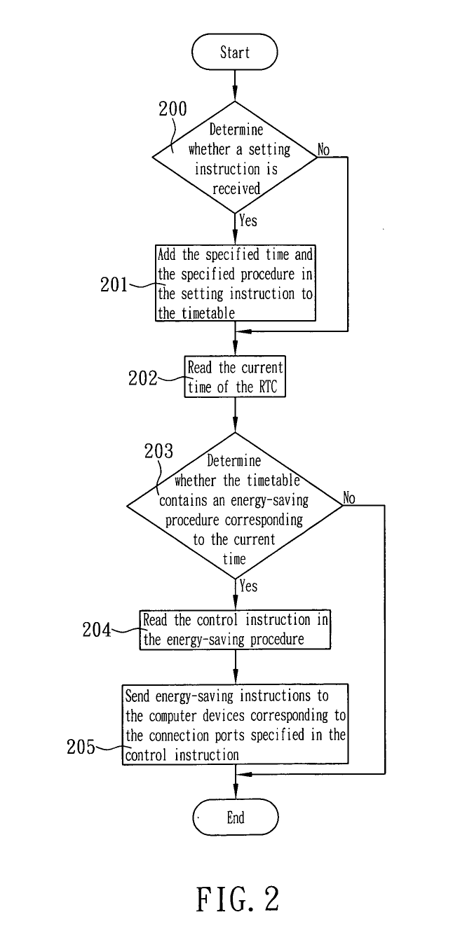

The present invention provides a method for simultaneously switching energy-saving modes of plural computer devices via a keyboard-video-mouse (KVM) switch. Referring to FIG. 1, the method is applied to a KVM switch 1 which includes a central processing unit (CPU) 10, a plurality of connection ports 11, a real-time clock (RTC) 12, a memory unit 13, and an input device port 14. The CPU 10 is respectively and electrically connected to each connection port 11, the RTC 12, the memory unit 13, and the input device port 14. Each connection port 11 is connected to a computer device 110 (e.g., a server, a host, etc.). The memory unit 13 is stored with a timetable which contains at least one scheduled time and at least one corresponding energy-saving procedure, wherein each energy-saving procedure includes a control instruction. The input device port 14 is connected to at least one input device 140 (e.g., a keyboard, mouse, etc.). Referring to FIG. 2 for a method according to the first preferred embodiment of the present invention, when the input device port 14 receives a setting instruction inputted via the input device 140, the CPU 10 performs the following steps.

Step 200: The CPU 10 determines whether or not it has received the setting instruction transmitted from the input device port 14. If yes, go to Step 201; if not, go to Step 202.

Step 201: The CPU 10 adds the specified time and the corresponding specified procedure that are included in the setting instruction to the timetable as a scheduled time and the corresponding energy-saving procedure, respectively.

Step 202: The CPU 10 reads the current time of the RTC 12.

Step 203: The CPU 10 determines whether or not the timetable contains a scheduled time corresponding to the current time. If yes, go to Step 204; if not, the process ends.

Step 204: The CPU 10 reads the control instruction in the energy-saving procedure corresponding to the scheduled time.

Step 205: The CPU 10 sends an energy-saving instruction or an awakening instruction to the computer device 110 connected to each of the plural connection ports 11 that are specified in the control instruction.

With the method described above, a manager can use the KVM switch 1 to simultaneously switch a plurality of computer devices 110 (e.g., all the computer devices 110 managed by the manager or a plurality of the computer devices 110 that belong to the same group) to the desired energy-saving modes or the working mode. For example, the energy-saving modes include a hibernation mode, a sleep mode, and the OFF mode. In the hibernation mode, a computer device 110 stores the currently processed data into a hard drive and is then turned off to stop receiving power and thereby save energy. In the sleep mode, a computer device 110 stores the currently processed data into a volatile memory, and after that, only the motherboard and the volatile memory of the computer device 110 keep receiving power to retain the data and thereby reduce power consumption. The working mode refers to the turned-on (ON) mode. By setting the energy-saving procedure(s) in the timetable, a manager can easily plan the timetable according to personal and managerial needs so that the KVM switch 1 is scheduled to automatically send the preset energy-saving or awakening instructions to the specified computer devices 110 at a time when the specified computer devices 110 are required to be simultaneously switched to the desired energy-saving or working modes.

For instance, if the manager needs all the computer devices 110 under his/her supervision to enter the sleep mode at 8:45 pm, the execution time (i.e., the specified time) as well as the intended mode and the connection ports 11 of all the computer devices 110 (i.e., the specified procedure) is inputted into the KVM switch 1 via the input device 140. The CPU 10 in the KVM switch 1 adds the specified time and the corresponding specified procedure to the timetable of the memory unit 13, and when the current time of the RTC 12 arrives at 8:45 pm, the KVM switch 1 switches the computer devices 110 connected to the specified connection ports 11 to the sleep mode. Hence, with the present invention, the manager need not switch and control the computer devices 110 sequentially as is conventionally required, and the efficiency and convenience of control over the computer devices 110 are increased.

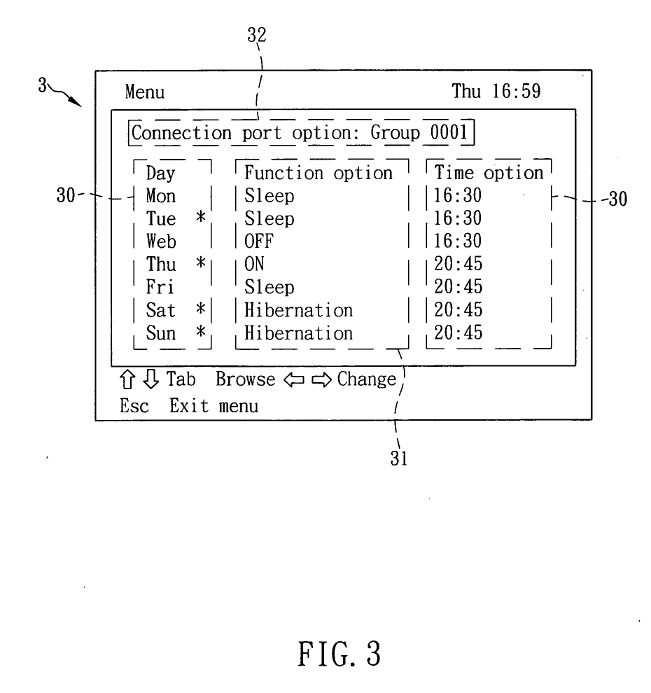

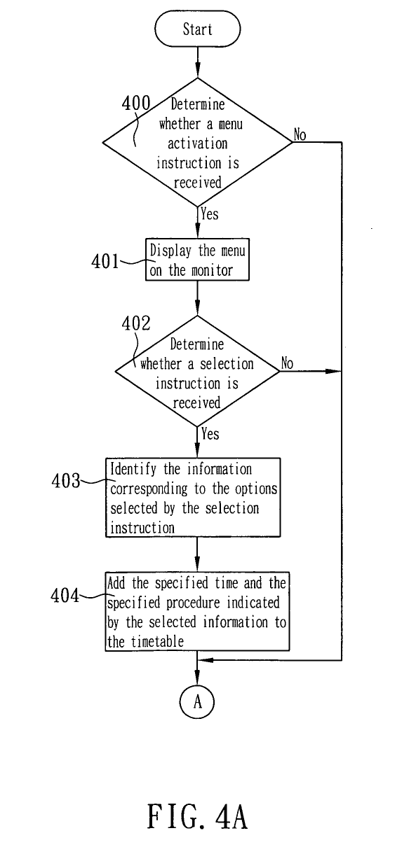

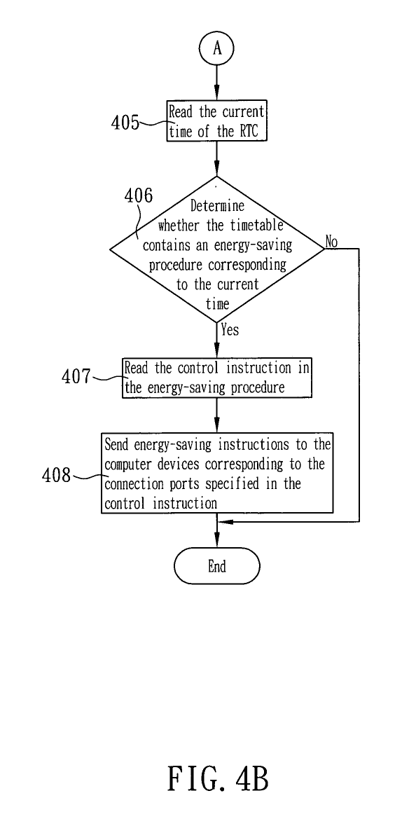

Referring back to FIG. 1, the KVM switch 1 further includes a display port. 15 and an on-screen display (OSD) module 16. The display port 15 and the OSD module 16 are respectively and electrically connected to the CPU 10. The display port 15 is connected to a monitor 150. The OSD module 16 is a chip provided directly on a circuit board of the KVM switch 1 and is configured for generating a menu 3 as shown in FIG. 3. The menu 3 at least includes a time option 30, a function option 31, and a connection port option 32. According to a method in the second preferred embodiment of the present invention as shown in FIGS. 4A and 4B, when the input device port 14 receives a menu activation instruction inputted via the input device 140, the CPU 10 performs the following steps.

Step 400: The CPU 10 determines whether or not it has received the menu activation instruction transmitted from the input device port 14. If yes, go to Step 401; if not, go to Step 406.

Step 401: The CPU 10 instructs the OSD module 16 to generate the menu 3 and then displays the menu 3 on the monitor 150, so as for a manager to view and make selections from the menu 3.

Step 402: The CPU 10 determines whether or not it has received a selection instruction transmitted from the input device port 14. If yes, go to Step 403; if not, go to Step 406.

Step 403: The CPU 10 identifies the information corresponding to the time option 30, the function option 31, and the connection port option 32 that are selected by the selection instruction.

Step 404: The CPU 10 adds to the timetable the specified time indicated by the information of the selected time option 30 and the corresponding specified procedure indicated by the information of the selected function option 31 and the selected connection port option 32, such that the specified time and the corresponding specified procedure serve as a scheduled time and the corresponding energy-saving procedure, respectively.

Step 405: The CPU 10 reads the current time of the RTC 12.

Step 406: The CPU 10 determines whether or not the timetable contains a scheduled time corresponding to the current time. If yes, go to Step 407; if not, the process ends.

Step 407: The CPU 10 reads the control instruction in the energy-saving procedure corresponding to the scheduled time.

Step 408: The CPU 10 sends an energy-saving instruction or an awakening instruction to the computer device 110 connected to each of the plural connection ports 11 that are specified in the control instruction.

The menu 3 displayed on the monitor 150 allows a manager to select and set the scheduled time and the corresponding energy-saving procedure in the timetable conveniently. Thus, when the scheduled time for simultaneously switching the specified computer devices 110 to the desired energy-saving or working modes arrives, the KVM switch 1 automatically sends the preset energy-saving or awakening instructions to the specified computer devices 110.

The process for setting the scheduled time and the corresponding energy-saving procedure is further described with reference to FIG. 3. If it is desired to switch all the computer devices 110 in a group 0001 to enter the sleep mode on Tuesday at 16:30, a manager can input/select the aforesaid time (i.e., Tuesday, 16:30) into/from the time option 30 and input/select the desired function (i.e., sleep mode) and the specified connection ports 11 (i.e., the connection ports corresponding to the computer devices 110 in the group 0001) into/from the function option 31 and the connection port option 32, respectively, thereby completing the process of setting the scheduled time and the corresponding energy-saving procedure. Thus, the computer devices 110 in the group 0001 are conveniently scheduled to enter the sleep mode at the preset time. The foregoing function of selecting and setting the scheduled time and the corresponding energy-saving procedure effectively increases the usefulness and convenience of the present invention.

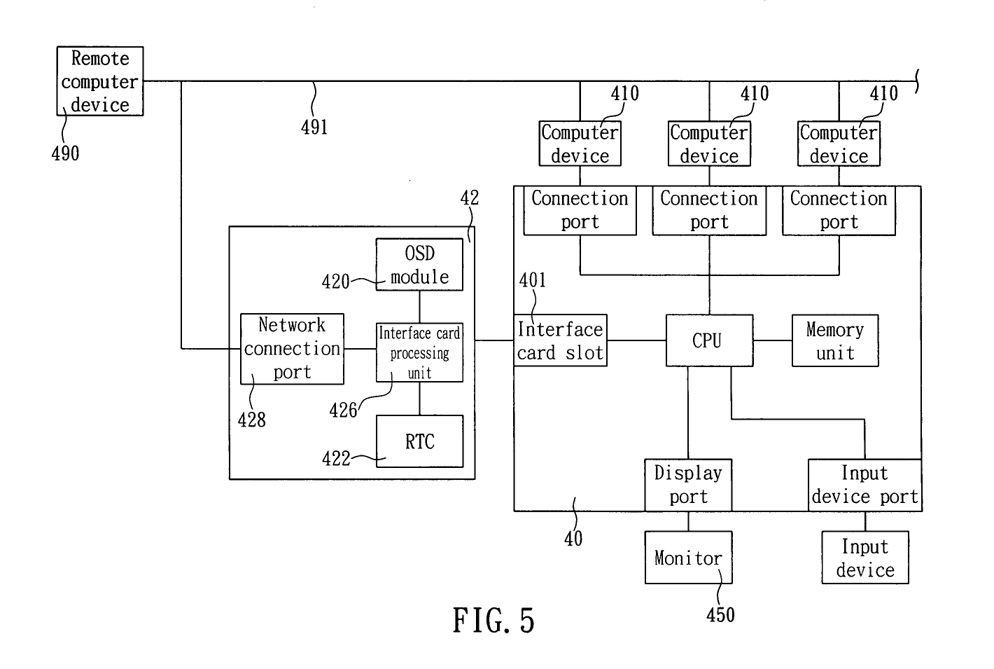

Referring again to FIG. 1, when the present invention is implemented, the RTC 12 and the OSD module 16 of the KVM switch 1 are not necessarily formed as chips built in the circuit board of the KVM switch 1. As shown in FIG. 5, the KVM switch 40 lacks the RTC 12 and the OSD module 16 in FIG. 1 but includes an interface card slot 401 for connecting with an interface card 42, wherein the interface card 42 is provided with an interface card processing unit 426, an RTC 422, an OSD module 420, and a network connection port 428. After the interface card 42 is inserted into the interface card slot 401 of the KVM switch 40, the KVM switch 40 is provided with the functions of the aforesaid components on the interface card 42. Thus, a manager can conveniently select and set the scheduled time and the corresponding energy-saving procedure in the timetable via the menu 3 (as shown in FIG. 3) displayed on the monitor 450, and when the scheduled time for simultaneously switching the specified computer devices 410 to the desired energy-saving or working modes arrives, the KVM switch 40 automatically sends the preset energy-saving or awakening instructions to the specified computer devices 410. The interface card 42 can be configured according to user needs and provided to the user. Hence, the functions of the KVM switch 40 can be expanded and enhanced by inserting different interface cards 42 into the KVM switch 40.

In addition, when the network connection port 428 of the interface card 42 is connected with a network cable 491 of a remote computer device 490, a manager can control the KVM switch 40 conveniently by the remote computer device 490 via the interface card 42, so as for the KVM switch 40 to send the preset energy-saving or awakening instruction to each computer device 410.

The processes of the previous embodiments can be shortened and simplified. In particular, Steps 200 and 201 in FIG. 2 and Steps 400 through 404 in FIG. 4A (i.e., the steps of setting the energy-saving procedure in the timetable via the input device 140 or the menu 3 of the OSD module 16) can be omitted. In that case, referring to FIG. 1, the KVM switch 1 is configured to function according to energy-saving procedure(s) preset in the timetable of the memory unit 13 and thereby switch the energy-saving modes of the specified computer devices 110 simultaneously. By so doing, the execution efficiency of the KVM switch 1 is effectively increased.

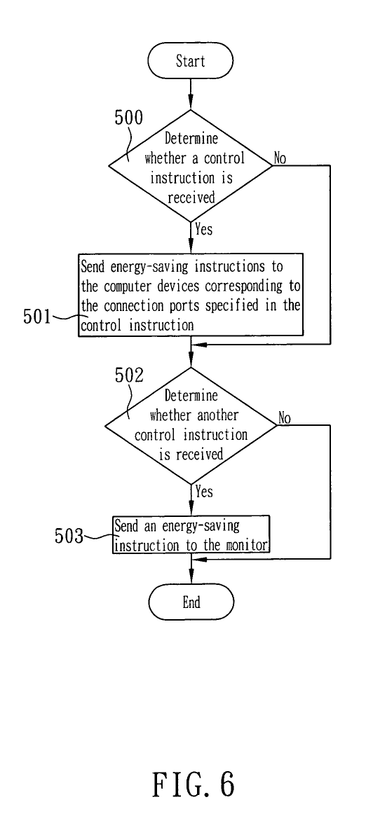

Please refer to FIG. 6 in conjunction with FIG. 1 for a method according to the third preferred embodiment of the present invention. When the input device port 14 receives a control instruction inputted via the input device 140, the CPU 10 performs the following steps.

Step 500: The CPU 10 determines whether or not it has received the control instruction transmitted from the input device port 14. If yes, go to Step 501; if not, go to Step 502.

Step 501: The CPU 10 sends an energy-saving instruction or an awakening instruction to the computer device 110 connected to each of the plural connection ports 11 that are specified in the control instruction.

Step 502: The CPU 10 determines whether or not it has received another control instruction transmitted from the input device port 14. If yes, go to Step 503; if not, the process ends.

Step 503: The CPU 10 sends another energy-saving instruction or another awakening instruction to the monitor 150.

The foregoing process allows a manager to input a control instruction directly through the input device 140 according to actual needs in controlling the computer devices 110 and thereby simultaneously switch the specified computer devices 110 to the desired energy-saving or working modes. Moreover, when there is no need to operate the KVM switch 1 or the computer devices 110 via the monitor 15 connected to the display port 15 of the KVM switch 1, the manager can send an energy-saving instruction through the KVM switch 1 to the monitor 15 to switch the monitor 15 to a low-power operation mode, thereby suspending the display function of the monitor 15 and saving energy effectively. When it is desired to reactivate the display function of the monitor 15, the manager sends an awakening instruction to the monitor 15 via the KVM switch 1, thus instructing the monitor 15 to resume its display function.

Furthermore, referring to FIG. 1, when the present invention is implemented, the designer of the execution programs of the KVM switch 1 may reduce the functions of the KVM switch 1 and simplify the processes of the disclosed embodiments according to product sales strategies. For instance, Steps 502 and 503 in FIG. 6 for switching the display function of the monitor 15 via the KVM switch 1 may be omitted such that the energy-saving modes of the computer devices 110 are switchable only via the KVM switch 1.

According to the above, referring to FIGS. 1 and 2, the method of the present invention allows a manager to use the KVM switch 1 to send energy-saving or awakening instructions to a plurality of computer devices 110 conveniently and thereby switch the computer devices 110 to the energy-saving or working modes simultaneously. In other words, with the present invention, the manager is spared the inconvenience of having to switch and control the computer devices 110 sequentially, as is conventionally required.

The embodiments described above are only the preferred embodiments and are not intended to limit the scope of the present invention. Therefore, all equivalent changes which are based on the technical contents disclosed herein and easily conceivable by a person skilled in the art should fall within the scope of the present invention, which is defined by the appended claims.

What is claimed is:

1. A method for simultaneously switching energy-saving modes of plural computer devices via a keyboard-video-mouse (KVM) switch, the method being applied to the KVM switch, the KVM switch comprising a central processing unit (CPU), a plurality of connection ports, a real-time clock (RTC), and a memory unit;
the CPU being respectively and electrically connected to each said connection port, the RTC, and the memory unit; each said connection port being connected to a said computer device; the memory unit storing a timetable, the timetable containing at least a scheduled time and at least a corresponding energy-saving procedure, each said energy-saving procedure comprising a control instruction; wherein the method comprises steps, performed by the CPU, of:
reading a current time of the RTC;
upon determining that the timetable contains a said scheduled time corresponding to the current time, reading the control instruction in the energy-saving procedure corresponding to the scheduled time; and
sending an energy-saving instruction to the computer device connected to each of plural said connection ports that are specified in the control instruction.

2. The method of claim 1, wherein the KVM switch further comprises an input device port electrically connected to the CPU and connected to an input device, and the method further comprises a step, performed by the CPU when the input device is operated to send a setting instruction to the input device port, of:
upon receiving the setting instruction transmitted from the input device through the input device port, adding to the timetable a specified time and a corresponding specified procedure in the setting instruction as a said scheduled time and a said corresponding energy-saving procedure, respectively.

3. The method of claim 1, wherein the KVM switch further comprises an input device port, a display port, and an on-screen display (OSD) module; the input device port, the display port, and the OSD module being respectively and electrically connected to the CPU; the input device port being connected to an input device; the display port being connected to a monitor; the OSD module configured for generating a menu, the menu comprising a time option, a function option, and a connection port option; the method further comprising steps, performed by the CPU when the input device is operated to send a menu activation instruction to the input device port, of:
upon receiving the menu activation instruction transmitted from the input device through the input device port, instructing the OSD module to generate the menu and displaying the menu on the monitor;
upon receiving a selection instruction transmitted from the input device through the input device port, identifying information corresponding to the time option, the function option, and the connection port option that are selected by the selection instruction; and
adding to the timetable a specified time indicated by the information corresponding to the selected time option and a specified procedure indicated by the information corresponding to the selected function option and the selected connection port option, as a said scheduled time and a said corresponding energy-saving procedure, respectively.

4. A method for simultaneously switching energy-saving modes of plural computer devices via a keyboard-video-mouse (KVM) switch, the method being applied to the KVM switch, the KVM switch comprising a central processing unit (CPU), an input device port, and a plurality of connection ports; the CPU being respectively and electrically connected to the input device port and each said connection port; the input device port being connected to an input device; each said connection port being connected to a said computer device; wherein the method comprises a step, performed by the CPU when the input device is operated to send a control instruction to the input device port, of:
upon receiving the control instruction transmitted from the input device through the input device port, simultaneously sending an energy-saving instruction to the computer device corresponding to each of plural said connection ports that are specified in the control instruction.

5. The method of claim 4, wherein the KVM switch further comprises a display port connected to a monitor, and the method further comprises a step, performed by the CPU when the input device is operated to send a second control instruction to the input device port, of:
upon receiving the second control instruction from the input device port, sending a second energy-saving instruction to the monitor corresponding to the display port.
